(19) United States
(12) Patent Application Publication
(10) Pub. No.: US 2006/0038752 A1
(43) Pub. Date: Feb. 23, 2006

(54) Emission display

(75) Inventor: Dustin L. Winters, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/922,607

(22) Filed: Aug. 20, 2004

(51) Int. Cl. G09G 3/30

(52) U.S. Cl. 345/76

(57) ABSTRACT

An emissive display device for producing images, has a plurality of first pixels each having an emissive area wherein the plurality of first pixels define a first viewing region, wherein each first pixel produces light emission which is visible when viewing the first side of the display device; and a plurality of second pixels each having an emissive area and wherein the plurality of second pixels define a second viewing region, wherein each second pixel produces light emission which is visible when viewing the second side of the display device, wherein at least a portion of the plurality of first and second pixels are interleaved.

### FIELD OF THE INVENTION

The present invention relates generally to OLED displays for producing images.

### BACKGROUND OF THE INVENTION

Full color organic electroluminescent (EL) devices, also known as organic light-emitting devices (OLED), have recently been demonstrated as a new type of flat panel display. Electroluminescent displays are emissive displays which generate light when electrically stimulated and do not require external light sources, such as the backlights such as are used in many liquid crystal displays (LCD). In simplest form, an organic EL device is comprised of an electrode serving as the anode for hole injection, an electrode serving as the cathode for electron injection, and an organic EL medium sandwiched between these electrodes to support charge recombination that yields emission of light. An example of an organic EL device is described in U.S. Pat. No. 4,356,429. In order to construct a pixilated display device such as is useful, for example, as a mobile phone display or digital camera display, individual organic EL elements can be arranged as an array of pixels in a matrix pattern. This matrix of pixels can be electrically driven using either a simple passive matrix or an active matrix driving scheme. In a passive matrix, the organic EL layers are sandwiched between two sets of orthogonal electrodes arranged in rows and columns. An example of a passive matrix driven OLED display is disclosed in U.S. Pat. No. 5,276,380. In an active matrix configuration, each pixel is driven by multiple circuit elements such as transistors, capacitors, and signal lines. Examples of such active matrix OLED displays are provided in U.S. Pat. Nos. 5,550,066, 6,281,634, and 6,456,013.

OLED displays can be made to have one or more colors. These displays are known as multi-color displays. Full color OLED devices are also known in the art. Typical full color OLED devices are constructed of pixels that are red, green, and blue in color. That is, these pixels emit light in the red, green, and blue regions of the visible light spectrum. As such, the emitted light from the pixels would be perceived to be red, green, or blue by a viewer. These differently colored pixels are sometimes referred to as sub-pixels which taken together as a group form a single full-color-pixel. Full color organic electroluminescent (EL) devices have also recently been described that are constructed of pixels that are red, green, blue, and white in color. Such an arrangement is known as an RGBW design. Examples of RGBW devices are disclosed in U.S. Patent Application Publication 2002/0186214 A1, U.S. 2004/0113875 A1 and U.S. Pat. No. 6,771,028.

Recently, several OLED displays that emit from both the front and rear sides of the display have been shown. Such displays take advantage of the emissive nature of the OLED device. Examples of such devices include Transparent Organic Light Emitting Devices (TOLED) such as described in U.S. Pat. No. 6,548,956 and K. H. Lee, “2.2” QCIF Full Color Transparent AMOLED Display”, SID 03 Digest, 2003, P104 as well as the Dual-Emission Active Matrix OLED such as described in Y. Nakamura, et al., “2.1-inch QCIF+Dual Emission AMOLED Display having Transparent Cathode Electrode”, SID 04 Digest, 2004, P1403. These displays have reduced size, weight, and cost compared to the use of two displays to display images in both directions.

However, such displays always emit from both directions simultaneously and are incapable of emitting only in one direction or switching between emitting from only one direction to emitting in only the opposite direction or to emitting in both directions simultaneously. Therefore, for applications where the display is at times viewed from only a single side, such devices waste power by emitting from both sides. Furthermore, such displays will display the same image in both forward and rear directions. This may cause the image to appear backward when viewed from one side, which is especially disadvantaged when displaying text. The image may be rotated by adjusting the video signal depending on which side of the display is likely being viewed by providing a sensor as described in U.S. Patent Application Publication 2004/0080468A1, however, this solution does not allow for simultaneous viewing of the correct image orientation from both sides and requires extra circuit components, such as a sensor.

### SUMMARY OF THE INVENTION

It is therefore an object of the present invention to provide a display which is capable of emitting from a forward only direction, a rear only direction, or both directions simultaneously.

It is another object of the present invention to provide a display that is capable of simultaneously displaying different images in the forward direction and the rear direction.

These objects are achieved by an emissive display device having a first side and second side for producing images, comprising:
a) a substrate having a first surface;
b) a plurality of first pixels each having an emissive area wherein the plurality of first pixels define a first viewing region, wherein each first pixel produces light emission which is visible when viewing the first side of the display device;
c) a plurality of second pixels each having an emissive area and wherein the plurality of second pixels define a second viewing region, wherein each second pixel produces light emission which is visible when viewing the second side of the display device, wherein at least a portion of the plurality of first and second pixels are interleaved;
d) first means disposed relative to the first pixels for directing light emission produced by the first pixels outwardly from the first side of the display while preventing light emission through the second side of the display; and
e) second means disposed relative to the second pixels for directing light emission produced by second pixels outwardly from the second side of the display while preventing light emission through the first side of the display.
   ,or both directions simultaneously. It is a further advantage of the present invention that it provides a display that is capable of simultaneously displaying the same or different images in the forward direction and the rear direction. It is a further advantage of the present invention that it a provides a such display capability in both a forward and rear direction at a reduced weight, size, and cost compared to using two separate displays to achieve display capability in both a forward and rear direction.

### BRIEF DESCRIPTION OF THE DRAWINGS

FIG. 1 shows an OLED display according to the present invention;

FIG. 2 shows another OLED display according to the present invention having an alternate pixel arrangement;

FIG. 3 shows a side cross-sectional view of an OLED display according to the present invention;

FIG. 4 shows a circuit diagram according to a first circuit embodiment of the present invention;

FIG. 5 shows a circuitry layout diagram according to the above first circuit embodiment of the present invention;

FIG. 6 shows a cross sectional view of a device according to the first circuit embodiment of the present invention;

FIG. 7 shows a circuit diagram according to the second circuit embodiment of the present invention;

FIG. 8 shows a timing chart showing the operation of a device according to the second circuit embodiment of the present invention;

FIG. 9 shows a circuitry layout diagram according to the second circuit embodiment of the present invention; and

FIGS. 10(A) to 10(C) are illustrations of an application employing a OLED display according to the present invention.

Since device feature dimensions such as layer thicknesses are frequently in sub-micrometer ranges, the drawings are scaled for ease of visualization rather than dimensional accuracy.

### DETAILED DESCRIPTION OF THE INVENTION

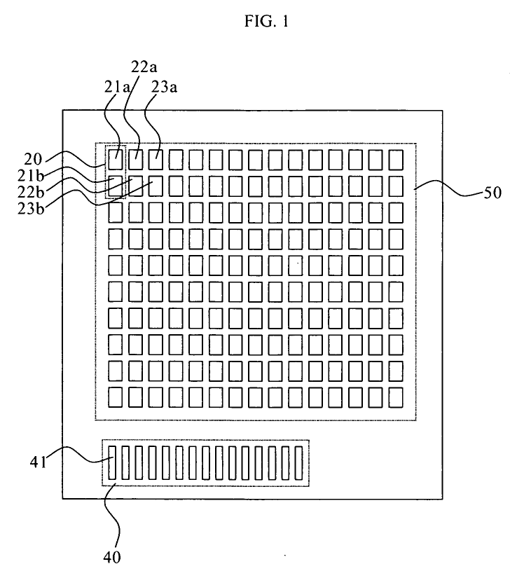

FIG. 1 shows an OLED display according to present invention. The display is composed of a pixel region 50 and a connector pad region 40. Connector pad region 40 is composed of one or more connector pads such as connector pad 41. These connector pads are conductive connections, which provide a location for making electrical connections to other electronic components, such as an integrated circuit chip or circuit board (not shown). The pixel region 50 is composed of multiple pixels such as pixels 21a, 21b, 22a, 22b, 23a, and 23b, preferably arranged in a matrix of rows and columns. For purposes of this invention, a pixel is considered any region of the display that can be individually stimulated to produce light. The pixels are arranged into groups, herein referred to as pixel pairs, such as pixel pair 20 including pixels 21a and 21b. Likewise, pixels 22a and 22b form another pixel pair and pixels 23a and 23b form yet another pixel pair. Within a pixel pair, one pixel is constructed so as emit in one direction, such as the forward direction, and the other pixel is constructed so as to emit in the opposite direction, such as the rear direction. While it is preferable that every pixel be grouped into a pixel pair, the present invention can be made to work when some pixels are not in pixels pairs. In such a case, it is possible that more pixels are made to emit in one direction, such as the forward direction, than the other direction. For simplicity of design and manufacturing process, pixels within a pixel pair are preferably constructed so as to emit the same color. That is, pixels 21a and 21b may be constructed so as to emit a red color, pixels 22a and 22b may be constructed so as to emit a green color, and pixels 23a and 23b may be constructed so as to emit a blue color. Displays having more or less than three colors such as Red, Green, Blue and White (RGBW) displays could also be constructed according to the present invention. While it is preferable that the pixels within a pixel pair be constructed so as to emit the same color, it is possible that the colors of the pixels of a pixel pair may vary slightly, due to differing optical interference effects which impact color. It is also possible that the pixels within a pixel pair could be constructed to emit different colors, such as a red and a blue pixel. It is also possible that one or more colors are only present for pixels emitting in one of the directions. For example, a display could be constructed according to the present invention comprising red, green, and blue pixels, which emit in one direction and only blue pixels, which emit in the other direction. This configuration would provide a monochrome image on one side and a full color image on the other. Such a configuration would allow for more pixels to be present per unit area or a higher ratio of emitting to non-emitting area in the full color direction compared to a display constructed so as to have red, green, and blue pixels in both directions. Alternately, a display could be constructed according to the present invention including red, green, and blue pixels, which emit in one direction and only white pixels, which emit in the other direction. Alternately, a display could be constructed according to the present invention including red, green, blue, and white pixels, which emit in one direction and only white pixels, which emit in the other direction. Alternately, a display could be constructed according to the present invention comprising red, green, blue, and white pixels, which emit in one direction and only red, green, and blue pixels, which emit in the other direction.

The pixels and pixel pairs shown here are arranged in a stripe pattern. However, the invention is not limited to this case and the pixels or the pixel pairs can be arranged into a variety of patterns known in the art such as a delta pattern. Examples of stripe and delta pixel pattern arrangements are shown in U.S. Patent Application Publication 2002/0070909A1.

The pixel region 50 may be driven by active matrix circuitry (not shown), which, can be fabricated on the display substrate. Power and video signals can be applied to display by making electrical wiring connections to the connector pads in the connector pad region 40, which can be connected to the active matrix circuitry.

While the pixels are shown as all being the same size, it is possible that the pixels can be designed to be different sizes. For example it is desirable when selecting the emitting area of a pixel which emits a particular color in a multi-color display to take into consideration the differing emission efficiencies, luminance ratios, and material lifetimes of the organic electroluminescent materials used to construct the pixel in order to minimize driving current density and thereby improve device life time. Device lifetime is determined by the loss of luminance brightness when driven at a nominal condition. Organic electroluminescent materials are known to degrade during operation, losing efficiency over time. This loss of efficiency will result in a display appearing dimmer over time. The end of life is defined as the operating time until a display reaches a level of unacceptable brightness loss, often 50% of the initial display brightness. Alternately, end of life can occur when pixels have decreased in brightness more than a certain percentage of neighboring pixels resulting in image burn in. It is desirable to maximize life. The rate of luminance loss is related to the amount of current per unit area (or current density) applied to the organic electroluminescent materials. The rate of luminance loss becomes more rapid at higher current densities. Therefore, it is desirable to minimize current density. However, since pixels of different colors in a multi-color display may have different efficiencies, may be driven at different intensities, or may have different material life times, it is desirable to construct these pixels so as to have different emitting areas in order to maximize device life. This concept has been described for displays that emit in one direction in patents such as U.S. Pat. No. 6,366,025. This optimization of pixel emitting areas can be applied to the display device of the present invention either to the pixels that emit in the forward direction, the pixels which emit in the rear direction, or both.

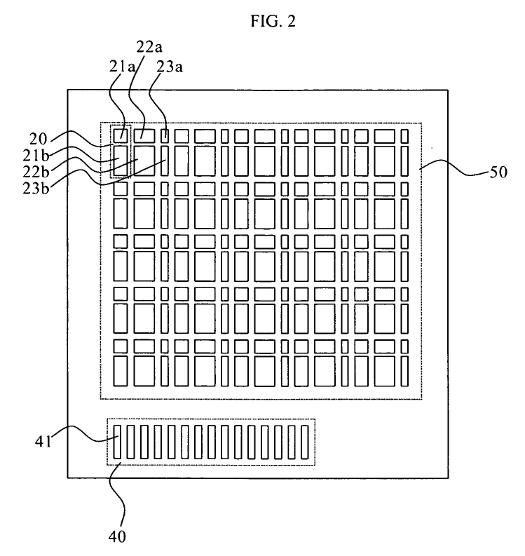

However, since the display of the present invention comprises pixels that emit in opposite directions and are operated simultaneously or independently, it is desirable to further optimize the display such that the emitting areas of pixels within a pixel pair are optimized. Such a configuration of the display is shown in FIG. 2. One side of the display may be driven to a brightness greater than the opposing side. For, example the display side closest to the operator may be driven to a brightness which is less that the opposing display side which may be viewed by someone at a further distance. This may be the case for a digital camera or mobile phone having a digital camera function where one side of the display is viewed by a person taking a picture and the other side is viewed by the person whom is having their picture taken. In this case, the pixels that emit on the side of the display which is brighter should be made to have a larger emitting surface area than the pixels which emit out the opposite direction so as to make the current densities for the two sets of pixels more even. However, the display may also be designed such that one of the sides is active more that the opposing side. For example one side of the display may be viewed 80% of the time the device is in use and the other side of the side may be viewed 40% of the time the device is in use, so that both sides of the display are viewed simultaneously 20% of the time the device is in use. As such, the pixels which emit on the side of the display which is used more frequently are preferably made to have a larger emitting area such that the lifetime of said pixels is increased such that the difference in time to end of life for both sides of the display is minimized. This results in the overall life of the product being increased. While it is shown in FIG. 2 that the ratio of the emitting areas of the different colored pixels for the pixels that emit in one direction is the same as that of the pixels which emit in the opposite direction, this is not required. That is, for example, the ratios of the surface area of the blue pixel emitting in forward direction to the surface area of the green and red pixels emitting in forward direction do not have to be the same as the ratios of the surface area of the blue pixel emitting in rear direction to the surface area of the green and red pixels emitting in rear direction.

The display is fabricated on a substrate, which may hold the driving circuitry such as the active matrix driving circuitry as is discussed in more detail below. Pixels either emit in the direction through this substrate or in the direction opposite the substrate. Pixels that emit in the direction opposite the substrate are referred to as top emitting pixels. The light emission of top emitting pixels is referred to as top emission light. Similarly, pixels that emit in the direction through the substrate are referred to as bottom emitting pixels. The light emission of bottom emitting pixels is referred to as bottom emission light. Since the circuitry tends to block bottom emission light, the emitting area of the top emitting pixels is preferably located over at least a portion of the circuitry. Particularly for the case of high resolution displays, the surface area of the substrate covered by circuitry may be large compared to the surface area of the substrate which is not covered by circuitry. Therefore, it is preferable that the top emitting pixels be made to have a larger area compared to the bottom emitting pixels to maximize overall product lifetime, particularly for applications as described above where the different sides of the display are driven to different brightness levels or have different amounts of usage time.

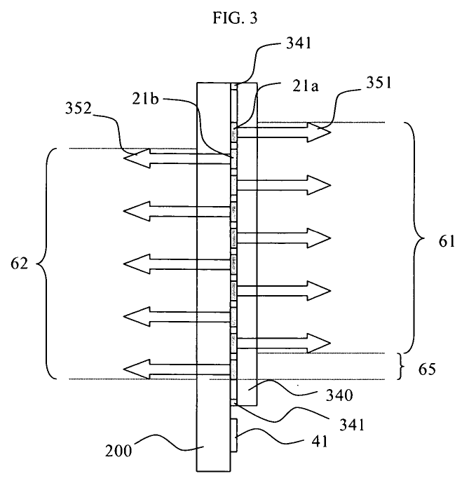

FIG. 3 shows a cross sectional view of a display according to the present invention. The device is composed of substrate 200 over which the pixels such as pixel 21a and pixel 21b are formed. The connector pads such as connector pad 41 are also formed over substrate 200. Pixel 21a is shown to produce top emission light 351. Pixel 21a along with the other pixels producing top emission light together define the top emission viewing region 61. Pixel 21b is shown to produce bottom emission light 352. Pixel 21b along with the other pixels generating bottom emission light together define the bottom emission viewing region 62. It can be seen that the top emission viewing region and bottom emission viewing region overlap. However, these regions typically do not completely overlap, creating non-overlapping regions such as non-overlapping region 65 around the edges of the top and bottom emission viewing areas. It is desirable to minimize these non-overlapping viewing to maintain a minimal overall device size. In FIG. 3, it is shown that non-overlapping lapping region 65 is approximately one pixel length in length. It is preferable that the non-overlapping regions are approximately the same length or width as a row or column or pixels respectively. In order to achieve these overlapping viewing regions, the pixels having top emission light and the pixels have bottom emission light are arranged in an interleaving fashion as shown. That is, for example, one or more top emission pixels are disposed between two or more bottom emission pixels such that at least a portion of the plurality of top and bottom emission pixels are interleaved. The pixels are further protected by cover plate 340, which is attached to substrate 200 by an adhesive seal 341. Further detail regarding the composition and construction of the pixels, the substrate, and the cover plate is described in detail below.

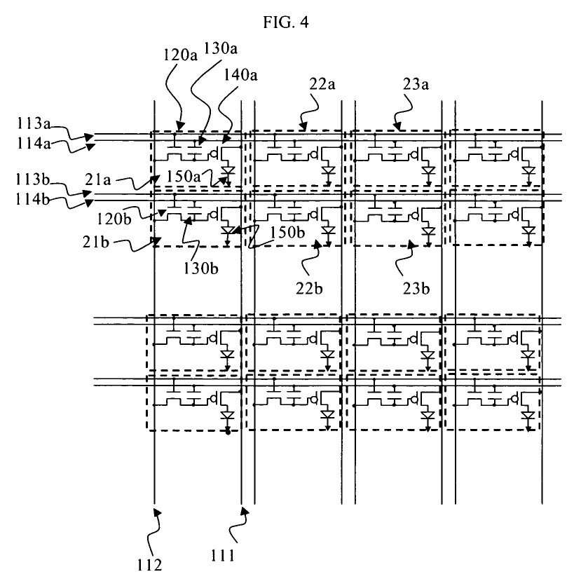

FIG. 4 shows a circuit pattern diagram for the pixel region of an active matrix display arranged according to the first circuit embodiment of the invention. The circuit can be considered in portions with each portion arranged to drive a pixel. For example, portions of the circuit are arranged to drive pixels 21a, 21b, 22a, 22b, 23a, 23b as shown. While only a small number of pixels are shown, this design can be extended to have many rows and columns of pixels.

The circuit is constructed of several circuit components arranged to drive the organic light emitting diode component. In general, these components include power lines, data lines, capacitor lines, select lines, select transistors, power transistors, and storage capacitors. A select line is a signal line that receives a voltage or current signal that determines which row of the display receives data from the data lines at a given time. All rows receive this signal at separate times during a frame. A data line is a line that supplies either a current or voltage signal to the pixel that determines the pixel's brightness. A power line is a signal line that supplies a power source to the organic light emitting diode of a pixel. A capacitor line is a signal line that supplies a reference voltage to one side of the storage capacitor. A capacitor line is preferred, but not required, to construct an active matrix pixel circuit. For example, the same signal line can serve the power line and capacitor line functions. A select transistor is a transistor activated by the signal on the select line to permit the signal from the data line to adjust the output of the organic light emitting diode, adjust the charge stored on the storage capacitor, or both. A power transistor is located in series between the power line and the organic light emitting diode and regulates is used to regulate the current flowing through the organic light emitting diode. A storage capacitor is used to maintain the voltage applied to the gate of the drive transistor after the row has been unselected by applying the appropriate signal to the select line to deactivate the select transistor.

Each portion of the circuit of FIG. 4 has several of such circuit components. For example, the portion of the circuit arranged to drive pixel 21a is composed of select transistor 120a, storage capacitor 130a, power transistor 140a, and organic light emitting diode 150a. These components are connected to data line 112 and power line 111 as shown, which are shared by all pixels in a column. These components are also connected to select line 113a and capacitor line 114a as shown, which are shared by all pixels in a row. The organic light emitting diodes are connected at their anode to a power transistor and at their cathode to a common electrode (not shown) shared by all the pixels. Alternately, the organic light emitting diodes could be constructed with the opposite polarity such that the cathodes are connected to the power transistors and the anodes are connected to a common electrode. This configuration would require the opposite voltage bias to be applied to the power lines and common electrode compared to the case shown.

The portion of the circuit arranged to drive pixel 21b is similarly composed of a select transistor 120b, storage capacitor 130b, power transistor 140b, and an organic light emitting diode 150b. This portion of the circuit is connected as shown to select line 113b and capacitor line 114b.

The drive circuitry operates in a manner well known in the art. Each row of pixels is selected by applying a voltage signal to the select line, which turns on the select transistor for each pixel in that row. The brightness level for each pixel is controlled by a voltage signal, which has been set on the data lines for each column. The storage capacitor for each pixel is then charged to the voltage level of the data line associated with that pixel and maintains the data voltage until the row is selected again during the next image frame. The storage capacitor is connected to the gate of the power transistor so that the voltage level held on storage capacitor regulates the current flow through the power transistor to organic light emitting diode and thereby controls brightness. The row is then un-selected by applying a voltage signal to the select line which turns off the select transistors of that row. The data signal, however, is retained by the storage capacitor. The data line voltages are then set to the levels desired for the next row and the select line of the next row is turned on. This is repeated for every row of pixels.

The circuit shown in FIG. 4 provides each pixel with a corresponding set of circuit components. The pixels forming a pixel pair, such as for example pixels 21a and 21b are shown here as being arranged with each pixel of the pixel pair connected to the same data line but arranged in a different row so that each pixel of the pixel pair is connected to a different select line. Alternately, the pixels of a pixel pair can be arranged so that the pixel are in the same row and are connected to the same select line, but are connected to different data lines. Alternately, separate data and select lines can be provided to the pixels of a pixel pair, although this configuration would require extra signal lines to be fabricated on the display, so that it is preferred that the pixels of the pixel pair share either a data line or a select line. In any of these configurations, the pixels of the pixel pair can be driven so that one emits but not the other or both emit simultaneously. If both pixels are emitting simultaneously, these pixels can be driven to emit with differing brightness so that different images can be displayed on each side of the display. Therefore, the objects of the present invention are achieved in the first circuit embodiment by providing separate circuitry and select lines or data lines to each of the pixels and constructing some of the pixels to emit in one direction and other pixels to emit in the opposite direction. This construction will be described in more detail below.

The circuit configuration described here to drive each pixel is one example configuration. Many variations of pixel driving circuit configuration are known in the art and can be applied to the present invention by one skilled in the art. For example, variations of this basic design are shown in U.S. Pat. Nos. 5,550,066; 6,429,599 and 6,476,419. Yet another circuit design is shown in U.S. Pat. No. 6,501,448 where two parallel transistors are connected in series between the organic light emitting diode and the power voltage supply line. In this type of design the two transistors are physically spaced in order to increase robustness to variability but together serve the same function as the single power transistor discussed above. Similarly, example circuits where single select transistors, such as in U.S. Pat. No. 6,429,599, and multiple select transistors connected in series, such as in U.S. Pat. No. 6,476,419, have been shown. In the above examples, the pixels are typically driven using a voltage data signal. However, further alternate designs where a current data signal is applied have been described in the art. Examples of some such current data signal type pixels circuits are discussed in U.S. Pat. Nos. 6,501,466; 6,535,185, 6,577,302 and U.S. Patent Application Publication 2003/0040149A1. These circuits have many arrangements for the circuit components and may have additional circuit components beyond those used in the circuit shown in FIG. 4.

In addition to the circuit components arranged in the pixel region to drive the pixels, the display device may include additional peripheral circuitry (not shown) to operate the rows and columns of the display by supplying signals to the select and data lines. This peripheral circuitry comprises several transistors and serves to receive video data signals from the connector pads in the connector pad region and in turn produce the proper signals to drive the select lines and data lines.

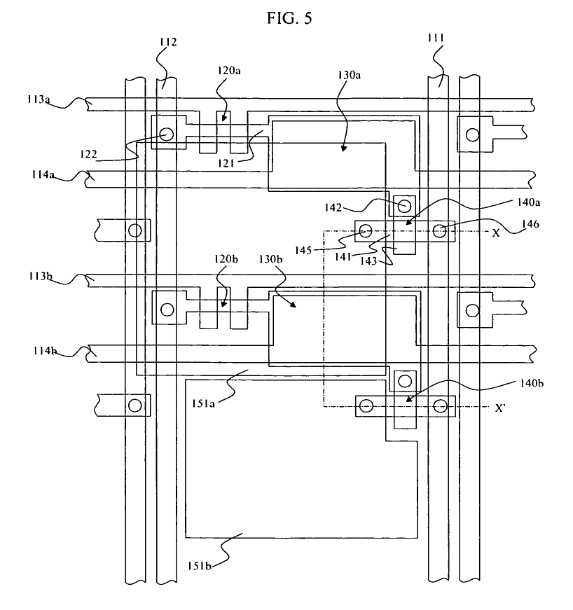

A layout diagram for the portions of the drive circuitry used to drive pixel 21a and pixel 21b is shown is shown in FIG. 5. FIG. 5, shows the construction of the various circuit components such as select transistor 120a, storage capacitor 130a, and power transistor 140a. The drive circuitry components are fabricated using conventional integrated circuit and thin film transistor fabrication technologies. Select transistor 120a is formed from a first semiconductor region 121 using techniques well known in the art. Similarly, power transistor 140a can be formed in a second semiconductor region 141. The first semiconductor region 121 and second semiconductor region 141 are typically formed in the same semiconductor layer. This semiconductor layer is typically silicon and is preferably polycrystalline or crystalline, but can also be amorphous. This first semiconductor region 121 also forms one side of storage capacitor 130a. Over the first semiconductor region 121 and second semiconductor region 141 is an insulating layer (not shown) that forms the gate insulator of select transistor 120a, the gate insulator for power transistor 140a, and the insulating layer of storage capacitor 130a. The gate of select transistor 120a is formed from part of select line 113a, which is formed in the first conductor layer. Power transistor 140a has a separate power transistor gate 143 also preferably formed in the first conductor layer. The other electrode of storage capacitor 130a is formed as part of capacitor line 114a, also preferably formed from the first conductive layer. Power line 111 and data line 112 are preferably formed in a second conductive layer. One or more of the signal lines (e.g. select line 113a) frequently cross at least one or more of the other signal lines (e.g. data line 112), which requires these lines to be fabricated from multiple conductive layers with at least one interlayer insulating layer (not shown) in between. The first electrode 151a of the organic light emitting diode is connected to power transistor 140a. An insulating layer (not shown) is located between the first electrode 151a and the second conductive layer.

Connections between layers are formed by etching holes (or vias) in the insulating layers such as via 122 connecting data line 112a to the first semiconductor region 121. Similarly, via 142 connects the power transistor gate 143 to first semiconductor region 121, via 146 connects the second semiconductor region 141 to power line 111, and the via 145 connects the second semiconductor region 141 the first electrode 151a.

Select transistor 120b, storage capacitor 130b, power transistor 140b are formed in a manner similar to that described above. In this case, select transistor 120b is connected to select line 13b. Storage capacitor 130b is connected to capacitor line 114b. Power transistor 140b is connected to first electrode 151b. Power transistor 140a and power transistor 140b can have the same or different channel length and width dimensions.

First electrode 151b and first electrode 151a serve to provide electrical contact to the organic electroluminescent media of the organic light emitting diodes. Over the perimeter edges first electrode 151b and first electrode 151a, an interpixel dielectric layer (not shown) may be formed to cover the edges of said electrodes and reduce shorting defects as described below. The emitting area of the pixels is defined by the area of the first electrodes which is in electrical contact with organic electroluminescent media. This area is the area of the first electrode reduced by any area covered by dielectric material. The viewable area of the emissive area may be further reduced by the presence of any opaque components, such as circuit components, located between the emissive area and the viewer. It is desirable to minimize such reduction in viewable area of the emissive area.

The first electrode 151b is arranged so a to be part of a pixel which is bottom emitting. That is light emitted from a bottom emitting pixel would exit the device through the substrate on which the circuitry is constructed. As such, it is formed in an area that is mostly free of other circuit features, which tend to block or reflect light. First electrode 151a, on the other hand, is arranged so as to be part of a pixel which is top emitting. That is light emitted from a top emitting pixel would exit the device is the direction approximately opposite to that of the bottom emitting pixel. Therefore, the pixel formed from first electrode 151a and the pixel formed from first electrode 151b together form a pixel pair.

Since the pixel formed from first electrode 151a is a top emitting pixel, it is not necessary for this pixel to be constructed in an area free of other circuit features. It is instead preferable that such a pixel be constructed over the various circuit components to make most efficient use of the space on the display substrate. First electrode 151a therefore is constructed in such a way as to be over at least a portion of many of the circuit features such as select transistor 120a, storage capacitor 130a, select line 113a, and capacitor line 114a. First electrode 151a may also constructed over the area of circuit features belonging to the other pixel such as select transistor 120b, storage capacitor 130b, select line 113b, and capacitor line 114b. This configuration allows for the most efficient use of space, thereby allowing the display to be high resolution or to have a high emitting to non-emitting area ratio (also referred to as aperture ratio).

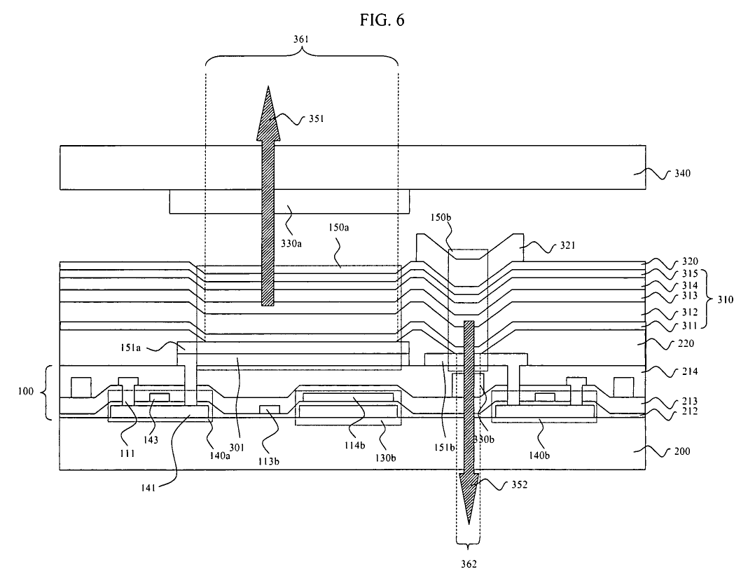

A cross-section view of the OLED device along line X-X′ is shown in FIG. 6. FIG. 6 illustrates the vertical construction of the various layers included in the pixels. The drive circuitry 100 is disposed over substrate 200 and under organic electroluminescent media 310 in a manner herein described. Over the substrate 200, a semiconductor layer is formed and doped in a manner known in the art. The semiconductor layer is then patterned to create regions such as the first semiconducting region and second semiconducting region 141. A gate insulating layer 212 is formed over the patterned semiconductor layer. Vias are formed in certain regions by removing the insulating layer. Over the gate insulating layer 212, gate conductors such as power transistor gate 143 are formed and patterned from a first conductor layer. In areas where vias are formed, electrical connections are made between the first conductor layer the semiconductor layer. The semiconductor layer may then be doped to form source and drain regions on either sides of the gate conductors, such as power transistor gate 143, in the area of the transistors by well-known methods such as ion implantation. Disposing the first conductor over the patterned areas of the semiconductor layer forms the transistors, such as power transistor 140a and power transistor 140b as well as the capacitors, such as storage capacitor 130b. An insulator layer 213 is formed over the gate conductors. Vias are formed in certain regions by removing areas of the insulating layers. Over insulator layer 213, a second conductor layer is deposited and patterned, forming power line 111 and the data line 112. In areas where vias where formed, electrical connections are made between the second conductor layer and lower layers such as the semiconductor layer as shown. Another insulator layer 214 is formed over the power and data lines. The drive circuitry shown here is an example of a top gate transistor having the semiconductor layer disposed between the gate and substrate. The invention can also be made to work by someone skilled in the art using a bottom gate transistor architecture where the gate is disposed between the semiconductor layer and the substrate.

Power transistor 140b is electrically connected to the first electrode 151b of organic light emitting diode 150b though a via. Since organic light emitting diode 151b is part of a pixel that is bottom emitting, that is light emission from the pixel passes through the substrate on the way to the viewer, first electrode 151b is preferably highly transparent in order to transmit such light. First electrode 151b can be formed of many materials known in the art which are useful for forming transparent electrodes such as, but not limited to, indium-tin oxide (ITO), indium-zinc oxide (IZO), zinc-tin oxide (ZTO), tin-oxide(SnOx), and indium oxide (InOx).

Similarly, power transistor 140a is electrically connected to the first electrode 151a of organic light emitting diode 150a through lower reflector 301, which is preferably electrically conductive and formed over a via to power transistor 140a. Light generated in the pixels is initially directed randomly in all directions. Therefore, light that is generated in an initial direction opposite to the intended direction needs to be redirected or blocked so as to not interfere with viewing of an image from the other side of the display. As such, lower reflector 301 is used to direct light generated by light emitting diode 150a away from the substrate so that organic light emitting diode 150a is top emitting, generating top emission light 351. Lower reflector 301 is preferably highly reflective as can be constructed of many materials such as, but not limited to, Aluminum, Silver, Gold, Platinum, Molybdenum, or various allows comprising one or more of said metals. Lower reflector 301 is preferably of a thickness greater than 60 nm and more preferably greater than 100 nm so as to not permit any transmission of light. Alternately, the device can be constructed so first electrode 151a of organic light emitting diode 150a is connected directly to power transistor 140a. However, while it is preferable that a reflective material is used for the lower reflector 301 in order to maximum light output, an alternate configuration using a highly absorbent film in place of lower reflector 301 can be employed to successfully practice the present invention. Such a configuration may improve contrast against incident ambient light by also absorbing such ambient light.

First electrode 151a is preferably constructed of a material such as, but not limited to, indium-tin oxide (ITO), indium-zinc oxide (IZO), zinc-tin oxide (ZTO), tin-oxide(SnOx), and indium oxide (InOx). First electrode 151a and first electrode 151b are preferably constructed of the same material and the same thickness so as to simplify manufacturing. The thickness of first electrode 151a may optionally be selected so as to properly tune optical reflections or microcavity optical distances in organic light emitting diode 150a. Such optical tuning techniques are known in the art. Alternately, the present invention can be made to work by eliminating the highly transparent first electrode 151a and having the lower reflector 301 serve both a reflecting and a first electrode carrier injecting function.

Around the edges of first electrode 151a and first electrode 151b an interpixel dielectric layer 220 is formed to reduce shorts between the first electrodes and the second electrode 320 that are caused by the topography change at the first electrodes' edges. Use of such electrode insulating films over the first electrodes is disclosed in U.S. Pat. No. 6,246,179. While use of the electrode insulating film 220 can have beneficial effects, it is not required for successful implementation of the invention. If an interpixel dielectric is used, then the emissive area of the pixels is defined by the opening in the interpixel dielectric region. For example, emission area 361 is formed in the opening of the interpixel dielectric for the top emission pixel. Similarly, emission area 362 is formed in the opening of the interpixel dielectric for the bottom emission pixel. If an interpixel dielectric is not used, then the emissive areas are defined by the dimensions of the first electrodes. The emission area for a bottom emission pixel may be further reduced by the presence of opaque circuit components in the path of the light.

Each pixel further includes organic layers forming an organic electroluminescent media 310. There are numerous configurations of the organic electroluminescent media 310 layers wherein the present invention can be successfully practiced. For example, multi-color displays can be constructed by using organic electroluminescent media arranged to produce a broad band or white spectra and in combination with patterned color filters. In this case, the organic electroluminescent media does not need to be patterned between pixels but instead can be common to the entire pixel area. Color filters are formed preferably by photolithographic methods and are disposed between the organic electroluminescent media and the viewer.

Alternately, different organic electroluminescent media can be used for each differently colored pixel. In this case, precision patterning is required between pixels. Precision patterning can be accomplished by several methods known in the art such as deposition through a shadow mask, thermal transfer by laser from a donor substrate, or in the case of polymer organic light emitting diodes, printing of solution by ink jet. Because these methods tend to have less accuracy in alignment than photolithography methods, pixel packing density or display resolution may not be as good as a display produced by the previously described method. If patterning of the organic electroluminescent media is performed between pixels having different colors, it is preferable that pixels of a pixel pair have the same organic electroluminescent media such that the electroluminescent media does not require patterning between the pixels of a pixel pair. This configuration eliminates the need for addition space to be provided between the pixels of a pixel pair so that the design can accommodate tolerances in the alignment of the patterning method, such as the precision shadow mask. Therefore, for example, each layer of organic electroluminescent media of the pixels of a pixel pair is deposited through the same opening in the shadow mask used in the deposition of each of said layers.

A third configuration useful for producing pixels that emit different colors involves placing an organic electroluminescent media that emits a broad band or white spectra within a microcavity structure. In this method, the organic electroluminescent media is placed between a reflector and a semitransparent reflector. The optical distance, which is the product of the refractive index and the thickness, of the layers between the reflector and the semitransparent reflectors is selected so as to resonate light of a particular wavelength corresponding to the desired color. This optical distance can be adjusted by varying one of the organic electroluminescent media layers or a layer such as the transparent first electrode or an another optical spacer layer. Varying a layer such as the transparent first electrode is preferable, so as to avoid the need to pattern the Organic EL media layers. In this configuration, however, the color of emitted light varies strongly with the angle at which the pixel is viewed. This color shift can be suppressed by inclusion of a color filter between the organic electroluminescent media and the viewer.

Yet another method of producing a multicolor display known in the art involves using a organic electroluminescent media arranged to produce high energy photons, such as blue photons. Color change media which covert the high energy photos to lower energy photons, such as blue to green or blue to red, are then disposed between the organic electroluminescent media as the viewer. This method also does not require precision patterning of the organic electroluminescent media. An example of an OLED display using color change media is discussed in U.S. Pat. No. 5,294,870.

In all cases of methods of producing a multi-color display, it is preferable that the organic electroluminescent media layers between the pixels of a pixel pair are continuous as shown, allowing for the highest density of pixels and minimizing non-emissive area of the display. However, if desired, one or more layers of the organic electroluminescent media layers can be patterned to be different for each pixel of a pixel pair.

The present invention can be made to work using any of these above described configurations or combinations of these configurations. The example shown in FIG. 6 uses a broad band or white light emitting OLED with color filters disposed between the organic electroluminescent media 310 and the viewer (not shown).

There are many examples of organic electroluminescent media known in the art. Some examples of organic electroluminescent media layers that emit broadband or white light are described, for example, in EP 1 187 235, EP 1 182 244, U.S. Pat. Nos. 5,683,823; 5,503,910; 5,405,709; 5,283,182 and U.S. Patent Application Publication 20020025419. The organic electroluminescent media 310 is typically constructed of several sub-layers such as a hole-injecting layer 311, a hole-transporting layer 312, a light-emitting layer 313, an electron-transporting layer 314, and an electron-injecting layer 315. This is an example arrangement of the organic electroluminescent media layer. Other arrangements having fewer layers or more layers can be applied to the present invention by one skilled in the art. For example, additional light-emitting layers can be used. Also, functions of these layers can sometime be combined into a single layer such as a light-emitting layer that also serves the function of electron transportation. The organic electroluminescent media layers can be constructed of small molecule organic materials, which are typically deposited by evaporation methods or by thermal transfer from a donor substrate. Alternately, the organic EL medium can be constructed of polymer materials, commonly referred to as PLEDs, which can be deposited by methods such as ink jet printing or solvent spin or dip coating. The organic electroluminescent media layers are typically constructed with a host material and one or more dopant material, which is present in a smaller amount, by mass, than the host material. Other alternate configurations where the order of these layers is reversed is also known in the art and can be employed to practice the present invention by one skilled in the art.

Over the organic electroluminescent media, the second electrode 320 is disposed. In an active matrix configuration, the second electrode may be common to all the organic light emitting diodes such as organic light emitting diode 150a and organic light emitting diode 150b. In a passive matrix configuration, the second electrode would need to be formed into rows. The second electrode is preferably highly transparent and can be constructed of materials such as, but not limited to, indium-tin oxide (ITO), indium-zinc oxide (IZO), zinc-tin oxide (ZTO), tin-oxide(SnOx), and indium oxide (InOx).

Alternately, the second electrode could be constructed of a thin metallic layer such as silver or alloys containing silver. Such a layer is preferably deposited by methods such as thermal evaporation in a vacuum chamber. Such a layer of thin metal should be preferably less than 30 nm in thickness so as to be both partially reflective and partially transparent. Such a layer is referred to as being semi-reflective. Use of such a layer would cause organic light emitting diode 150a to be surrounded by a microcavity structure. That is, the organic media layers in the area of organic light emitting diode 150a would be disposed between a reflector, lower reflector 301, and a semitransparent reflector. This would result in light produced by organic light emitting diode 150a to resonate between lower reflector 301 and the semi-reflective second electrode. A particular wavelength of light will be preferentially enhanced by this resonance while other wavelengths of light will be diminished. This particular wavelength is determined by adjusting the optical distance between the reflector and the semi-reflective layer. This can be done, preferably, by adjusting the thickness of the transparent first electrode. In this case, the color filter 330a is not required as the light is already predominately colored by the microcavity effect. However, a color filter can still be used to suppress color shift when the device is viewed at angles other than the normal angle.

Light generated in the pixels is initially directed randomly in all directions. Therefore, light that is generated in an initial direction opposite to the intended direction needs to be redirected or blocked so as to not interfere with viewing from the other side. As such, upper reflector 321 is disposed above the second electrode 320 in the area of organic light emitting diode 150b. This upper reflector is constructed of a highly reflective material such as aluminum, silver, gold, magnesium-silver, or alloys containing these metals. The upper reflector 321 is preferably of a thickness greater than 60 nm and more preferably greater than 100 nm so as to not permit any transmission of light. The upper reflector may be patterned using methods such as deposition through a shadow mask. Upper reflector 321 reflects light generated in organic light emitting diode 150b downward through the substrate toward the viewer (not shown) so that organic light emitting diode 150b is bottom emitting. That is, organic light emitting diode produces bottom emission light 352. Alternately, upper reflector 321 can be disposed under the second electrode 320. In this case, the upper reflector would need to serve the electrode function of the second electrode for organic light emitting diode 150b. The reflector needs to be patterned so as cover organic light emitting diode 150b and avoid overlapping adjacent top emitting pixels. While it is preferable that a reflective material is used for the upper reflector 321 in order to maximum light output, an alternate configuration using a highly absorbent film in place of upper reflector 321 can be employed to successfully practice the present invention. Such a configuration may improve contrast against incident ambient light by also absorbing such ambient light.

Color filter 330a and color filter 330b are disposed in the paths of top emission light 351 and bottom emission light 352 respectively, as shown. The color filters serve the purpose of creating colored light from a broad emitting organic electroluminescent media source or suppressing the color shift of microcavity structures when viewed at non-normal angles. Color filters are constructed of materials such a polymer dyes which transmit light of a desired color while absorbing light of other colors. Such materials and their fabrication methods are well known in the art.

However, the use of color filters is not essential for implementation of the present invention. That is, constructions of the organic electroluminescent media are known that generate colored light that does not require filtering. Also, microcavity structure effects can be used to generate colored light emission from a broad emission electroluminescent media and may not require a color filter, especially if a wide viewing angle is not required. Therefore, alternate embodiments of the present invention can be constructed without color filters, or color filters in the path of either the top emission light or the path of the bottom emission light but not necessarily both.

Alternately, when the device is constructed with an appropriate organic electroluminescent media that emits high energy photons, the color filters can be replaced by color change media or used in combination with color change media. Color change media covert high energy photos produced by the organic electroluminescent media to lower energy photons, such as blue photons to green photons or blue photons to red photons.

Color filter 330a is shown as being constructed on cover plate 340. Cover plate 340 is preferably highly transparent and constructed of a material such as glass or plastic or a combination of glass and plastic. Cover plate 340 is useful for providing physical protection for the top surface of the device. This is important for a device of the present invention which will have the top surface, at least at some times, physically exposed to the environment and the user for viewing. The cover plate 340 may also be used to aid in encapsulation of the device. That is, some of the materials, such as the materials used in the organic electroluminescent media are known to degrade upon exposure to oxygen or moisture. The device may, therefore need to be sealed to prevent moisture from entering the device. This may be accomplished by using a cover plate 340, such as is shown, and sealing the device with an impermeable material or adhesive around the perimeter outside of the pixel region. This may leave a gap between the cover plate 340 and the top layer disposed on substrate 200. Such a gap is preferably filled with a dry or inert gas such as Nitrogen, Argon, or Helium. Alternately, the gap may be filled either completely or partially with a filler material having sufficient transparency such as a polymer. Additionally, moisture absorbing material such a desiccant may be used to inside the sealed region to absorb moisture. If such desiccant is disposed in the path of the top emission light, it should be highly transparent. In either case, it is preferable to minimize this gap to prevent light generated in one pixel from entering that of a neighboring pixel's color filter. This undesirable effect is referred to a pixel cross-talk.

Alternately, the device may be sealed by using thin film encapsulation (not shown). Thin film encapsulation methods such as depositing low permeability organic or inorganic materials over the pixel region are known in the art and can be used in the present invention if the thin films are suitably transparent to the top emission light 351. An example of a thin film encapsulation processes is described in U.S. Patent Application Publication 2001/052752A1 which describes a thin film encapsulation process comprising a metal oxide deposited by an Atomic Layer Deposition (ALD) method. Another example of a thin film encapsulation using alternating silicon oxide and silicon nitride films is given in H. Lifka et al., “Thin Film Encapsulation of OLED displays with a NONON Stack”, SID 04 Digest, 2004, P1384. If a thin film encapsulation is used, the cover plate may optionally be eliminated. However, a cover plate is still desirable even with thin film encapsulation for mechanical protection of the display.

While color filter 330a is shown as being located on the cover plate, it may alternately be disposed over substrate 200 over organic light emitting diode 150a. This has the advantage of locating the color filter closer to organic light emitting diode 150a, which minimizes pixel cross-talk. In this case, the color filter deposition and patterning process needs to be selected such that it does not damage the organic materials. If a thin film encapsulation is used, the color filter may be disposed on the thin film encapsulation which protects the organic materials from such processing. Alternately, the color filter may be located on the opposite side of cover plate 340 although this configuration increases the problem of pixel cross-talk. Yet another approach would involve locating the color filter on another supporting substrate, which is then aligned and attached to the cover plate.

Similarly, color filter 330b may be located in locations other than that which is shown. For example, it may be located directly on substrate 200, on the opposite side of substrate 200 or on yet another substrate, which is then aligned and attached to the opposite side of substrate 200.

Cover plate 340 may also be attached to contrast enhancement films such as are known in the art. These may include films such as, for example, circular polarizers and anti-glare or anti-reflection coatings. Similarly, contrast enhancement films may be applied to the bottom surface of substrate 200.

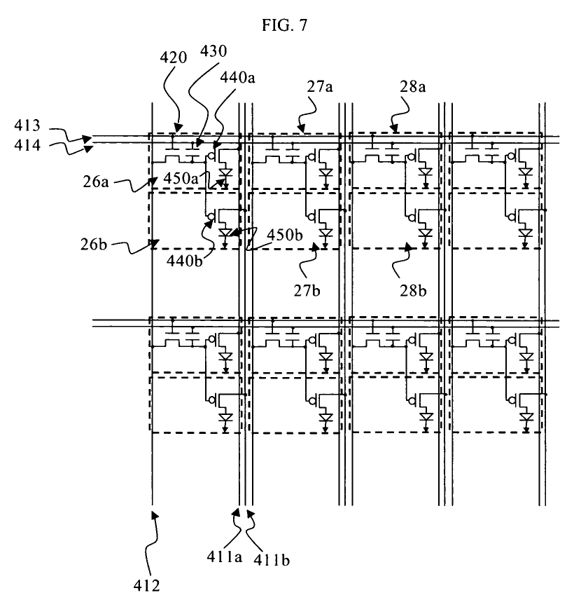

FIG. 7 shows a circuit pattern diagram for the pixel region of an active matrix display arranged according to the second circuit embodiment of the invention. The circuit is arranged to drive an array of pixels such as pixels 26a, 26b, 27a, 27b, 28a, and 28b. The pixels are arranged into pixel pairs with pixel 26a and pixel 26b being a pixel pair, pixel 27a and pixel 27b being another pixel pair, and pixel 27a and pixel 27b being yet another pixel pair. Each pixel in the pixel pair, is constructed so as to emit in the opposite direction from one and other, as described previously. In this embodiment, select transistor 420 is connected to storage capacitor 430, data line 412, and select line 413 as shown. Storage capacitor 430 is also connected as shown to capacitor line 414. Select transistor 420 and storage capacitor 430 are further connected to the gates of power transistor 440a and power transistor 440b as shown. Power transistor 440a is connected in series between power line 411a and organic light emitting diode 450a. Power transistor 440b is connected in series between power line 411b and organic light emitting diode 450b. As such, the pixels of a pixel pair share a common select transistor and storage capacitor but have different power transistors, which are connected to different power lines. The organic light emitting diodes are connected at their anode to a power transistor and at their cathode to a common electrode (not shown) shared by all the pixels. Alternately, the organic light emitting diodes could be constructed with the opposite polarity such that the cathodes are connected to the power transistors and the anodes are connected to a common electrode. This configuration would require the opposite voltage bias to be applied to the power lines and common electrode compared to the case shown.

This drive circuitry operates in a manner as follows. Each row of pixel pairs is selected by applying a voltage signal to the select line, which turns on the select transistor for each pixel pair in that row. The storage capacitor for each pixel pair is then charged to the voltage level of the data line associated with that pixel pair and maintains the data voltage until the row is selected again during the next image frame. Each power line in the pair, for example power line 411a and power line 411b, can be powered high or low depending on whether the display is intended to emit in the forward direction, the rear direction, or in both directions. For a power line to be powered high, a voltage greater than the voltage applied to the common electrode connected to the cathodes of the organic light emitting diodes is applied. In this case, the organic light emitting diode connected to that power line through a power transistor is forward biased and can emit depending on the data signal applied to the gate of the power transistor. For a power line to be powered low, a substantially lower voltage is applied, preferably a voltage equal to or less than the voltage applied to the common electrode connected to the cathode of the organic light emitting diodes. In this case, the organic light emitting diode would be reverse biased and would not emit. Alternately, if the organic light emitting diodes are constructed with the opposite polarity, that is the anodes are connected to the common electrode, then the voltages applied to the power lines would be opposite to those described above. The brightness level for each pixel is controlled by the voltage signal stored on the storage capacitor. The storage capacitor is connected to the gate of the power transistor. For power transistors connected to a power line having a high applied voltage, current will flow through the organic light emitting diode. The current level will be regulated by the data voltage stored on the storage capacitor connected to the power transistor's gate. Either or both of the transistors may pass current depending on the state of the power line associated with the transistor.

The row is then un-selected by applying a voltage signal to the select line which turns off the select transistors of that row. The data signal, however, is retained by the storage capacitor. The data line voltages are then set to the levels desired for the next row of pixel pairs and the select line of the next row is turned on. This is repeated for every row of pixels.

By operating the device as described above, the display can be made to emit from in the forward direction, the rear direction, or both by applying a high voltage signal to either or both of the power lines. The pixels of a pixel pair share a common select transistor, storage capacitor, select line, and capacitor line. This allows the pixel pairs to be constructed smaller therefore enabling a higher resolution display. Alternately this configuration leaves more surface area free of circuit components so that a larger region is available for emission in the direction through the substrate or the pixels can be constructed in a greater density.

When operating a device according to this second circuit embodiment of the present invention in a mode where the same image is to be displayed in both directions, the device can be operated as described above. In this case, the image would appear inverted from one direction compared to the other direction. If, however, different images are desired on each side, then some additional steps can be taken in operating the device to enable this function. In this case, the image frame can be divided into four portions.

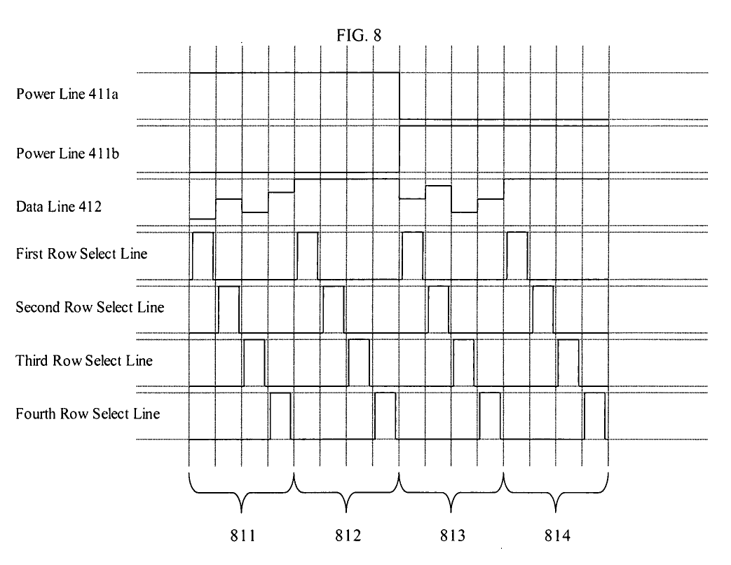

An example of this mode of operation is shown in FIG. 8. In this example, the operation of a device having four rows of pixel pairs is shown. As such the device is constructed with a first row select line, a second row select line, a third row select line, and a fourth row select line. The operation of a single column having a single data line, such a data line 412, and two power lines such as power line 411a and power line 411b, is shown. A single image frame is shown. For example, for a display operating at 20 Hz, this frame time is approximately 5 ms. As described above, the frame is sub-divided into a first frame portion 811, a second frame portion 812, a third frame portion 813, and a fourth frame portion 814. For this example of a display operating at 20 Hz, each of these frame portions would be approximately 1.25 ms in duration.

During the first frame portion 811, the data signal lines, such as data line 412 are set to the values desired for the image of the first side of the display. The power line for the pixels that emit from the first side of the display, such as power line 411a, are set high and the power lines for the opposite side, such as power line 411b, are set low. The select lines for the four rows are sequentially pulsed as the data line signals are updated for each row. During the second frame portion 812, the data line signal is set to a level that turns the power transistor off producing a dark or black output from the organic light emitting diode. For a p-type power transistor connected as shown in FIG. 7, this is a high voltage. The select lines for the four rows are again sequentially pulsed as the data line signals are updated for each row. The pixel data are therefore sequentially erased during this second frame portion. During the third frame portion 813, the power lines are reversed. For example, power line 411a is set low and power line 411b is set high. Data is then loaded for the opposite side of the display in the same manner as during the first frame portion 811. The select lines for the four rows are again sequentially pulsed as the data line signals are updated for each row. During the fourth frame portion 814, the data lines are again set to the dark or black level, and the select lines are sequentially pulsed. This sequence is repeated for subsequent frames.

Since in this mode of operation, each pixel is only on for a fourth of a frame, the brightness of each pixels needs to be set to a level approximately four times brighter than that used for modes where the pixels are on for the entire frame. While only four rows are shown, this scheme can be expanded to a large number of rows. Similarly, while only one data line is shown for a single column, this scheme can be expanded to a large number of columns. Although, by using this mode of operation, the pixels of a pixel pair are not both emitting at exactly the same instance, the time difference between the emissions will be small. As such, both sides of the display will still appear to viewers to be simultaneously displaying images that may be different.

The circuit described in FIG. 6 and operating scheme described in FIG. 8 are an example circuit. Many modifications, similar to those described in the first circuit embodiment, can be applied to the second circuit embodiment of the present invention by one skilled in the art. Current data and voltage data schemes can both be made to work in the present invention by one skilled in the art.

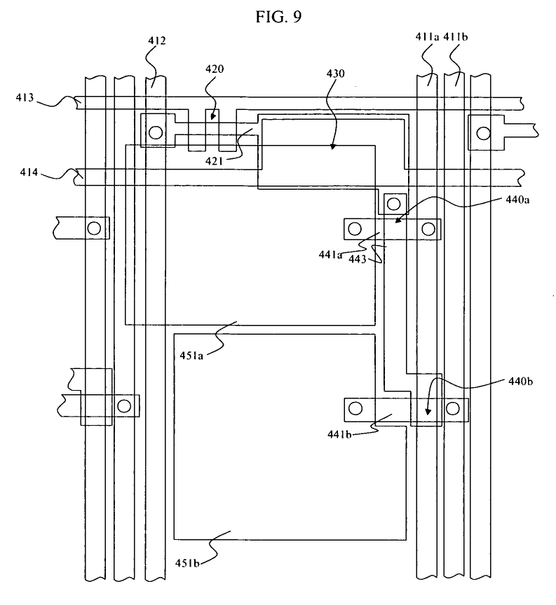

A layout diagram for the portions of the drive circuitry used to drive pixel 26a and pixel 26b is shown is shown in FIG. 9. FIG. 9, shows the construction of the various circuit components such as select transistor 420, storage capacitor 430, power transistor 440a, and power transistor 440b. The drive circuitry components are fabricated using conventional integrated circuit and thin film transistor fabrication technologies, as described for the first circuit embodiment. Select transistor 420 is formed from a first semiconductor region 421 using techniques well known in the art. Similarly, power transistor 440a can be formed in a second semiconductor region 441a and power transistor 440a can be formed in a third semiconductor region 441b. The first semiconductor region 421, second semiconductor region 441a, and third semiconductor region 441b are preferably formed in the same semiconductor layer. This semiconductor layer is typically silicon which can be amorphous, polycrystalline, or crystalline. This first semiconductor region 421 also forms one side of storage capacitor 430. Over the first semiconductor region 421, second semiconductor region 441a, and third semiconductor region 441b is an insulating layer (not shown) that forms the gate insulator of select transistor 420, the gate insulator for power transistor 440a, the gate insulator for power transistor 440b, and the insulating layer of storage capacitor 430a. The gate of select transistor 420 is formed from part of select line 413, which is formed in the first conductor layer. Power transistor 440a has a power transistor gate 443 also preferably formed in the first conductor layer. The other electrode of storage capacitor 430 is formed as part of capacitor line 414, also preferably formed from the first conductive layer. Power line 411a, power line 411b, and data line 412 are preferably formed in a second conductive layer. One or more of the signal lines (e.g. select line 413) frequently cross at least one or more of the other signal lines (e.g. data line 412), which requires these lines to be fabricated from multiple conductive layers with at least one interlayer insulating layer (not shown) in between. A first electrode 451a of the organic light emitting diode is connected to power transistor 440a. Power transistor 440a is also connected to power line 411a. An insulating layer (not shown) is located between the first electrode 451a and the second conductive layer. Power transistor 440b shares the same power transistor gate 443 with power transistor 440a. For one of the power transistors, such as power transistor 440b, the gate and channel region may be formed under a power line, such as power line 411a. This configuration decreases the risk of a voltage signal on the power line interfering with the operation of the power transistor. However, this configuration is not required for a successful implementation of the present invention. Power transistor is connected to a first electrode 451b and power line 411b. Power transistor 440a and power transistor 440b can have the same or different channel length and width dimensions. Connections between the various conductor layers and semiconductor layers are made through vias formed in the insulating layers as described in the first circuit embodiment.

The first electrode 451b is arranged so a to be part of a pixel which is bottom emitting. That is light emitted from a bottom emitting pixel would exit the device through the substrate on which the circuitry is constructed. As such, it is formed in an area that is mostly free of other circuit features, which tend to block or reflect light. First electrode 451a, on the other hand, is arranged so as to be part of a pixel which is top emitting. That is light emitted from a top emitting pixel would exit the device is the direction approximately opposite to that of the bottom emitting pixel. Therefore, the pixel formed from first electrode 451a and the pixel formed from first electrode 451b together form a pixel pair.

Since the pixel formed from first electrode 451a is a top emitting pixel, it is not necessary for this pixel to be constructed in an area free of other circuit features. It is instead preferable that such a pixel be constructed over the various circuit components to make most efficient use of the space on the display substrate. First electrode 451a therefore is constructed in such a way as to be over at least a portion of many of the circuit features such as select transistor 420, storage capacitor 430, select line 413, and capacitor line 414. This configuration allows for the most efficient use of space, thereby allowing for the display to be high resolution or to have a high emitting to non-emitting area ratio (also referred to as aperture ratio).

The vertical arrangement of the drive circuitry component layers is similar to that described in the first circuit embodiment. Furthermore, the organic electroluminescent media layers can have the same construction as the first circuit embodiment. The cover plate, thin film encapsulation, color filter, and color change media optional components are also the same as described in the first circuit embodiment.

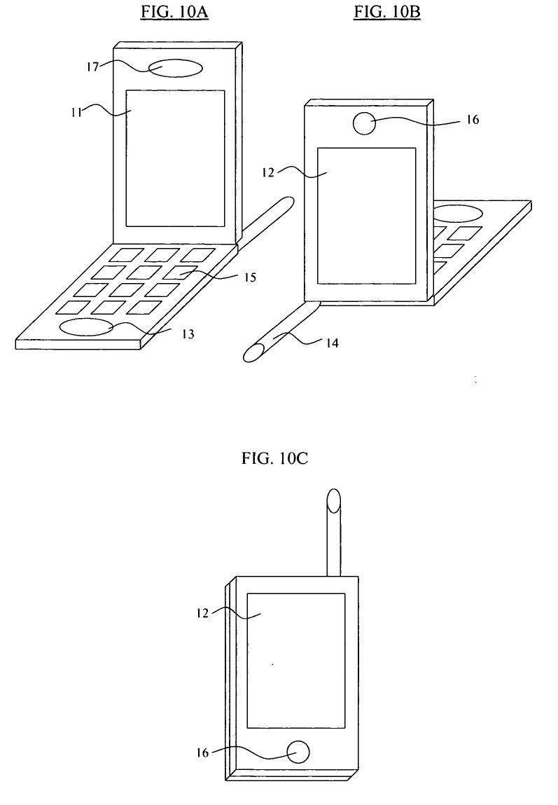

FIG. 10A, FIG. 10B, and FIG. 10C show a mobile phone application utilizing a display according to the present invention according to either the first or second circuit embodiment. FIG. 10A shows the mobile phone in an open position viewed from the front. FIG. 10B shows the mobile phone in an open position viewed from the rear. FIG. 10C shows the mobile phone in closed position. The mobile phone includes a microphone 13 for receiving audio information from the user, an antenna 14 for transmitting data, a keypad 15 for receiving input from the user, and a speaker 17 for outputting audio information. These features allow the mobile phone to fulfill a mobile phone function. The mobile phone further includes a digital camera 16 for capturing images and thereby fulfilling a camera function. A forward display window 11 and rear display window 12 provide an opening in the mobile phone body to view the emission from the display, which is housed inside the phone. These windows may be openings or may be filled with a transparent cover such as plastic or glass.

The mobile phone may be operated in a manner such as follows. When the user is using the phone to send or receive audio information or to enter information via the key pad 15, the side of the display emitting through the forward display window 11 may be actively displaying information while the side of the display emitting through the rear display window 12 may be off, or not emitting. This configuration saves power in this mode of operation compared to both sides of the display emitting since viewing from the rear direction is not required. When the user is viewing the mobile phone in the closed position, the side of the display emitting through the rear display window 12 may be actively displaying information while the side of the display emitting through the forward display window 11 may be off, or not emitting. This configuration saves power in this mode of operation compared to both sides of the display emitting since viewing from the forward direction is not required. When the user is using the phone to for a camera function using the digital camera 16, both sides of the display may be emitting. The images shown on both sides of the display may be the same or may be different.

Inside the phone, in addition to the display, several components such as a battery and one or more controller devices are required to operate the mobile phone, camera and display. The controller device may be one or more integrated circuit chips or one or more circuit boards or a combination thereof. At least one controller device is required to provide an image signal to the display via the displays connector pad region. This image signal may be provided as either a voltage signal or a current signal. The image signal is adjusted or calibrated according to the luminance and efficiency properties of the organic electroluminescent media of each pixel to provide a range of values from minimum brightness or off to full brightness. The image signal is sent to the display either row by row, column by column, or both.

Since the display according to the present invention is preferably constructed with a single connector pad region on the display substrate as described previously, all electrical connections between the controller devices and the display are preferably made on one side of the display. As such, it is preferable that the same controller device or devices are used to operate both of the sides of the display. This controller device is preferably connected to the display via a single electrical connection cable. This configuration is preferred so as to reduce the number of controller devices and electrical connection cables used in the display mobile phone device. Additional controller devices and electrical connection cables would increase the weight and cost of the mobile phone device. Therefore, the present invention is advantaged over existing devices that utilize two opposing displays, such as some mobile phones, that have more than one electrical connection cable or controller devices connected to the displays.

The invention has been described in detail with particular reference to certain preferred embodiments thereof, but it will be understood that variations and modifications can be effected within the spirit and scope of the invention.

### PARTS LIST

11 forward display window
12 rear display window
13 microphone
14 antenna
15 key pad
16 digital camera
17 speaker
20 pixel pair
21a pixel
21b pixel
22a pixel
22b pixel
23a pixel
23b pixel
26a pixel
26b pixel
27a pixel
27b pixel
28a pixel
28b pixel
40 connector pad region
41 connector pad
50 pixel region
61 top emission viewing region
62 bottom emission viewing region
65 non-overlapping region
100 drive circuitry
111 power line

### Parts List Cont'd

112 data line
113a select line
113b select line
114a capacitor line
114b capacitor line
120a select transistor
120b select transistor
121 first semiconductor region
122 via
130a storage capacitor
130b storage capacitor
140a power transistor
140b power transistor
141 second semiconductor region
142 via
143 power transistor gate
145 via
146 via
150a organic light emitting diode
150b organic light emitting diode
151a first electrode
151b first electrode
200 substrate
212 gate insulating layer
213 insulating layer
214 insulating layer
220 interpixel dielectric layer

### Parts List Cont'd

301 lower reflector
310 organic electroluminescent media
311 hole-injecting layer
312 hole-transporting layer
313 light-emitting layer
314 electron-transporting layer
315 electron-injecting layer
320 second electrode
321 upper reflector
330a color filter
330b color filter
340 cover plate
341 seal
351 top emission light
352 bottom emission light
361 emission area
362 emission area
411a power line
411b power line
412 data line
413 select line
414 capacitor line
420 select transistor
421 first semiconductor region
430 storage capacitor
440a power transistor
440b power transistor
441a second semiconductor region
441b third semiconductor region
443 power transistor gate

### Parts List Cont'd

450a organic light emitting diode
450b organic light emitting diode
451a first electrode
451b first electrode
811 first frame portion
812 second frame portion
813 third frame portion
814 fourth frame portion

1. An emissive display device having a first side and second side for producing images, comprising:
a) a substrate having a first surface;
b) a plurality of first pixels each having an emissive area wherein the plurality of first pixels define a first viewing region, wherein each first pixel produces light emission which is visible when viewing the first side of the display device;
c) a plurality of second pixels each having an emissive area and wherein the plurality of second pixels define a second viewing region, wherein each second pixel produces light emission which is visible when viewing the second side of the display device, wherein at least a portion of the plurality of first and second pixels are interleaved and wherein the emissive area of the at least one or more first pixels is greater than the emissive area of the at least one or more second pixels;
d) first means disposed relative to the first pixels for directing light emission produced by the first pixels outwardly from the first side of the display while preventing light emission through the second side of the display; and
e) second means disposed relative to the second pixels for directing light emission produced by second pixels outwardly from the second side of the display while preventing light emission through the first side of the display.

2. The emissive display of claim 1 wherein the plurality of first pixels and the plurality of second pixels further include one or more organic electroluminescent layers disposed between a first electrode and a second electrode.

3. The emissive display of claim 2 wehrein at least one of the plurality of first pixels and at least one of the plurality of second pixels includes the same organice eletroluminiscent layers.

4. The emissive display of claim 2 wherein all the first pixels and all the second pixels includes the same organic luminescent layers.

5. (canceled)

6. The emissive display device of claim 1 wherein
the substrate is transparent and the plurality of first pixels and the plurality of second pixels are formed over the first surface of the substrate.

7. The emissive display of claim 1 further comprising driving circuitry for activating the first and second pixels.

8. The emissive display of claim 7 wherein the drive circuitry causes the same or different images to be formed in the first and second viewing regions.

9. The emissive display of claim 7 wherein drive circuitry is formed over the first surface of the substrate

10. The emissive display of claim 7 wherein at least a portion the emissive area of one or more first pixels is disposed over at least a portion of the driving circuitry.

11. (canceled)

12. The emissive display of claim 7 wherein the driving circuitry includes at least one transistor for each of the first pixels and second pixels.

13. The emissive display of claim 7 wherein the driving circuitry includes at least one select transistor and one power transistor for each of the first pixels and at least one select transistor and one power transistor for each of the second pixels.

14. (canceled)

15. (canceled)

16. The emissive display of claim 1 wherein one or more of the first pixels or one or more of the second pixels further includes a color filter, a color change media, or both.

17. The emissive display of claim 1 further comprising a transparent cover plate disposed over the first and second pixels.

18. The emissive display of claim 17 wherein the pixels are sealed between the transparent cover plate and the substrate.

19. The emissive display of claim 1 further comprising at least one thin film encapsulation layer disposed over the first and second pixels.

20. The emissive display device according to claim 1 which functions in a mobile phone or a camera or both.

21. The emissive display device according to claim 1 which further includes an integrated circuit driving controller connected to the display, wherein the integrated circuit driving controller provides the electronic image information for the first side and the second side of the display.

22. The emissive display device according to claim 1 wherein the first and second means each include an absorbing layer or a reflective layer or both associated with the first and second pixels.

23. An emissive display device having a first side and second side for producing images, comprising:
a) a substrate having a first surface;
b) a plurality of first pixels each having an emissive area wherein the plurality of first pixels define a first viewing region, wherein each first pixel produces light emission which is visible when viewing the first side of the display device;
c) a plurality of second pixels each having an emissive area and wherein the plurality of second pixels define a second viewing region, wherein each second pixel produces light emission which is visible when viewing the second side of the display device, wherein at least a portion of the plurality of first and second pixels are interleaved;
d) first means disposed relative to the first pixels for directing light emission produced by the first pixels outwardly from the first side of the display while preventing light emission through the second side of the display;
e) second means disposed relative to the second pixels for directing light emission produced by second pixels outwardly from the second side of the display while preventing light emission through the first side of the display; and
f) driving circuitry for activating the first and second pixels and wherein each of the one or more first pixels and each of the one or more second pixels further includes at least one electroluminescent layer disposed between a first electrode and a second electrode and wherein the driving circuitry further comprises;
i) at least a first power line and a second power line;
ii) one or more data lines;
iii) at least one first power transistor electrically connected between the first power line and the first electrode of one of the one or more first pixels to regulate the current flow between the first power line and the first electrode of the one of the one or more first pixels;
iv) at least one second power transistor electrically connected between the second power line and the first electrode of one of the one or more second pixels to regulate the current flow between the second power line and the first electrode of the one of the one or more second pixels; and
v) at least one select transistor electrically connected so as to permit a voltage or current signal from at least one of the one or more data lines to adjust the current flow through the at least one first power transistor and the current flow through the at least one second power transistor.

24. An emissive display device having a first side and second side for producing images, comprising:
a) a substrate having a first surface;
b) a plurality of first pixels each having an emissive area wherein the plurality of first pixels define a first viewing region, wherein each first pixel produces light emission which is visible when viewing the first side of the display device;
c) a plurality of second pixels each having an emissive area and wherein the plurality of second pixels define a second viewing region, wherein each second pixel produces light emission which is visible when viewing the second side of the display device, wherein at least a portion of the plurality of first and second pixels are interleaved;
d) first means disposed relative to the first pixels for directing light emission produced by the first pixels outwardly from the first side of the display while preventing light emission through the second side of the display;
e) second means disposed relative to the second pixels for directing fight emission produced by second pixels outwardly from the second side of the display while preventing light emission through the first side of the display; and
f) driving circuitry for activating the first and second pixels and wherein one or more of the first pixels and one or more of the second pixels further includes at least one electroluminescent layer disposed between a first electrode and a second electrode and wherein the driving circuitry further comprises;
(i) one or more first power lines;
(ii) one or more second power lines;
(iii) one or more data lines;
(iv) one or more select lines;
(v) a first power transistor having a terminal electrically connected to the first electrode of a first pixel, and a terminal electrically connected to a first power line, and a gate terminal;
(vi) a second power transistor having a terminal electrically connected to the first electrode a second pixel, and a terminal electrically connected to a second power line and a gate terminal;
(vii) a storage capacitor electrically connected to the gate of the first power transistor and to the gate of the second power transistor; and
(viii) a select transistor having a terminal electrically connected to a data line and having a terminal electrically connected to the storage capacitor and electrically connected to the gate of the first power transistor and electrically connected to the gate of the second power transistor, and having gate terminal electrically connected to a select line.
